(19) United States
(12) Patent Application Publication
(10) Pub. No.: US 2015/0012258 A1
(43) Pub. Date: Jan. 8, 2015

(54) SYSTEM AND METHOD FOR MODELING AND CHARACTERIZING OF PHOTOVOLTAIC POWER SYSTEMS

(71) Applicant: Holden R. Caine, Boulder, CO (US)

(72) Inventor: Holden R. Caine, Boulder, CO (US)

(21) Appl. No.: 14/326,342

(22) Filed: Jul. 8, 2014

Related U.S. Application Data
(60) Provisional application No. 61/843,640, filed on Jul. 8, 2013.

(51) Int. Cl. G01R 31/40; G06F 17/50

(52) U.S. Cl. CPC H02S 50/00; G06F 17/5009
USPC 703/18

(57) ABSTRACT

A system and method of the invention adjusts an existing system model of a PV system to provide better information regarding projected performance of the PV system. The resulting model enables a user to more accurately compare actual versus expected performance, thereby quantifying performance degradation due to soiling, aging and component failures while also verifying the design assumptions. A method of the invention includes selecting days of historical data that will result in the highest quality results (e.g., high energy output, minimal clouds); determining key metrics and relationships between measured data and site characteristics to identify how to optimize model parameters; running simulations of the model over the key days to determine the best value for each model parameter that results in the closest match between the model and measured system output; and conducting iterations of the simulations to adjust various model parameters.

### FIELD OF THE INVENTION

Embodiments of the present invention relate to a system and method for modeling and characterizing photovoltaic power systems, and more particularly, to modeling of photovoltaic power systems, taking into account historical and real time site and weather conditions to produce accurate estimates of system performance in order to identify and value projected or modeled system performance versus actual system performance, and to assign a financial value for the difference between the two performances.

### BACKGROUND OF THE INVENTION

Commercial and utility-scale photovoltaic (PV) power systems require a significant initial investment and ongoing maintenance effort in order to meet their performance and financial expectations over the lifetime of the system. Considerable work has been done with regards to modeling of PV systems during the design process using tools such as PVsyst and SAM. After a system is installed and operating, monitoring systems typically provide simpler tools for performance assessment, such as the performance ratio between power output and measured irradiance.

Although modeling of PV systems is known, and while performance variables may be well documented, significant errors still exist in a comparison between baseline model predictions and actual performance of PV systems. Errors can be mitigated by adjusting existing model parameters and incorporating additional transforms at various points in the calculations of the model to compensate for more subtle relationships between the site conditions and characteristics, and the actual performance of the evaluated PV system.

Some prior art PV models predict PV system performance over a wide range of operating conditions from a set of measurements. The accuracy of the model is dependent on the quality and quantity of the data. For smaller systems, cost constraints may limit the number of sensors to simply an irradiance sensor and module temperature sensor, while larger systems may afford more accurate and a wider variety of sensors, including wind speed, humidity, rain, multiple irradiance sensors and others. In either case, the final result of this analysis will be a Performance Index value, defined as the ratio of measured output power to the power output calculated from the system model:

$$Pindex = \frac{Poutput}{Pmodel}$$

FIG. 1 illustrates an example prior art PV system model and the sequence of calculations used to determine PV system power output based on measured irradiance and other site conditions such as module orientation, latitude, longitude, elevation and others. These calculations represent a set of known relationships within a PV system. The PV model typically starts with measured irradiance and module temperature. Given those values, and by applying the appropriate transforms based on latitude, longitude, elevation, time of day, day of the year, PV module azimuth and tilt and other characteristics of the PV system, the output power (electrical kW) is calculated from the input solar irradiance (watts per meter), temperature, and other measurements. Each component of the system can be modeled by functions of varying complexity, often as simply as a constant multiplier. The basic model corresponds to the system as follows:
1. Convert measured irradiance to Plane of Array (POA) irradiance which is the amount of sunlight falling on the PV modules.
2. Adjust the irradiance for angle of incidence (PV modules may have difference characteristics for how well they absorb sunlight from different angles).
3. Adjust the irradiance for atmospheric effects (air mass). The spectrum of sunlight changes as a function of how much atmosphere the in the optical path.
4. Adjust for shading due to obstacles.
5. Adjust the module efficiency (modules operate at different efficiencies depending on the amount of sunlight and temperature).
6. Adjust for inverter efficiency. The inverter converts the DC power from the PV system in AC power, and the conversion efficiency varies as a function of power level and other effects.
7. Apply a de-rate factor to compensate for various losses, such as wiring and transformer losses.

### SUMMARY OF THE INVENTION

According to the system and method of the present invention, information is gathered from an operating PV system and a set of weather and other sensors in order to adjust an existing system model of the PV system to provide better information regarding projected performance. The resulting model enables a user to more accurately compare actual versus. expected performance, thereby quantifying performance degradation due to soiling, aging and component failures while also verifying the design assumptions.

According to one aspect of the invention, an updated or revised PV system model is created, taking into account historical and real time site and weather conditions to produce more accurate PV system performance, so that slight variations relative to an original PV system model can be identified and valued. An original PV system model is enhanced using historical data from PV monitoring capabilities of the original PV system, and as necessary, additional monitoring capabilities can be employed in the PV system to further enhance data-gathering. The analyzed historical data produces a baseline set of observed parameters that better characterize actual system performance, allowing for more precise performance assessment and fault detection when the actual system performance deviates from the model prediction.

According to a general method of the invention, a first step is to determine the best days or group of days for data analysis. These days may be selected according to preselected parameters in which it is desired to improve the current PV modeling system. For example, if it is known that the Pmodel data for days having a certain number of hours of sunlight observably differs from the actual Poutput data, these days could be sampled. A next step in the method is to select data value(s), reference data value(s), and/or model parameters or functions to adjust for the key dates. A next step in the method is to seek optimal model parameter(s) for the key dates, for example, matching of best correlations, analysis of maximums and minimums, and deviations between data. A next step in the method is to then apply optimal and revised model parameters to more accurately predict system performance. These revised model parameters will differ from the original system parameters from the original PV system model.

The environment in which the system and method of the invention are found is a data processing system. More specifically, the original PV system model is found within a monitoring application that comprises measurement hardware, an analysis engine, and a database for storing monitoring conditions, performance thresholds, performance data, and analysis data. The monitoring system may include one or more general purpose computers in which the analysis engine is in the form of firmware or a software program, and in which the system model enables a user to generate outputs for analysis, such as graphical user interfaces, printed reports, and others. In accordance with another aspect of the invention, the monitoring application is supplemented with programming instructions that incorporate the system and method of the present invention in terms of further analyzing system performance so that ultimately a more accurate PV system performance can be predicted. In connection with this last aspect, the system and method of the present invention may also be provided in the form of another software program or module that supplements the software program of the original PV system model. Both the PV system model software and the supplemental software of the invention may be web based applications that enable a user to remotely monitor PV system parameters, and to execute additional programming functions commensurate with the overall functions and purposes of the method.

Considering the above features of the invention, it may be considered a system for modeling photovoltaic power (PV) systems comprising: (i) a photovoltaic string for converting sunlight into electrical energy; (ii) a combiner for combining the output signals of a plurality of photovoltaic strings; (iii) an inverter for converting the DC output signals of a plurality of combiners into AC power; (iv) a sensor for detecting data associated with a plurality of photovoltaic strings; (v) a monitoring system for monitoring the performance of a photovoltaic array, comprising: (1) a memory; (2) a processor in connection with the memory, the processor operable to execute software modules, the software modules comprising: (3) a PV system model module operable to provide data and user interfaces associated with the determination of a performance index value defined as a ratio of measured power output to power output calculated from a PV system model (4) a supplemental module operable to provide data and user interfaces associated with model simulations of the PV system to identify and value projected or modeled PV system performance versus actual PV system performance, the supplemental module being further operable to select significant days of historical data, identify relevant metrics and relationships between measured data and site characteristics to identify how to optimize model parameters, run simulations of the PV system model over the selected days to determine a value for each model parameter that results in a match between a selected model parameter and corresponding measured system output, and conduct iterations of the simulations to adjust selected model parameters; and (5) a web application operable to receive user-selectable conditions and to display performance data associated with the data entry.

In another aspect, the invention may be considered a method for modeling photovoltaic power (PV) systems, the method comprising: (1) providing a photovoltaic system comprising: (i) a photovoltaic string for converting sunlight into electrical energy; (ii) a combiner for combining the output signals of a plurality of photovoltaic strings; (iii) an inverter for converting the DC output signals of a plurality of combiners into AC power; and (iv) a sensor for detecting data associated with a plurality of photovoltaic strings; (2) providing a PV system model module associated with a computer processor operable to provide data and user interfaces associated with the determination of a performance index value defined as a ratio of measured power output to power output calculated from a PV system model; (3) providing a supplemental module operable associated with said computer to provide data and user interfaces associated with model simulations of the PV system to identify and value projected or modeled PV system performance versus actual PV system performance, the supplemental module being further operable to select significant days of historical data, identify relevant metrics and relationships between measured data and site characteristics to identify how to optimize model parameters, run simulations of the PV system model over the selected days to determine a value for each model parameter that results in a match between a selected model parameter and corresponding measured system output, and conduct iterations of the simulations to adjust selected model parameters; (4) determining, via a processor, a comparison between selected model parameters and corresponding measured system outputs to determine discrepancies, and to adjust said selected model parameters to more closely match the corresponding system outputs; and (5) displaying said comparison on at least one of a user interface display associated with a computer, a text message, an email message, or a printed report.

Other features and advantages of the system and method of the invention will become apparent from a further review of the detailed description and accompanying figures. Further, the Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is an example communications/data processing network system that may be used in conjunction with embodiments of the present disclosure;

FIG. 2 is an example computer system that may be used in conjunction with embodiments of the present disclosure;

FIG. 3 is a schematic diagram illustrating components of a prior art PV system model;

FIG. 4 depicts a general method of the present invention;

FIG. 5 is an example inverter efficiency curve; and

FIG. 6 is an example graph showing a performance index with and without a derived inverter correction function applied in which the applied correction function reduces error.

FIG. 7 is an example of a typical monitoring system that gathers both environmental data and electrical data for a PV system

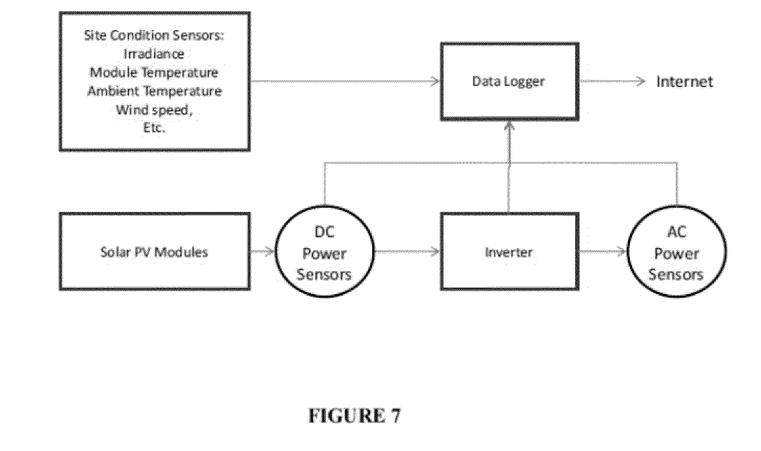

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

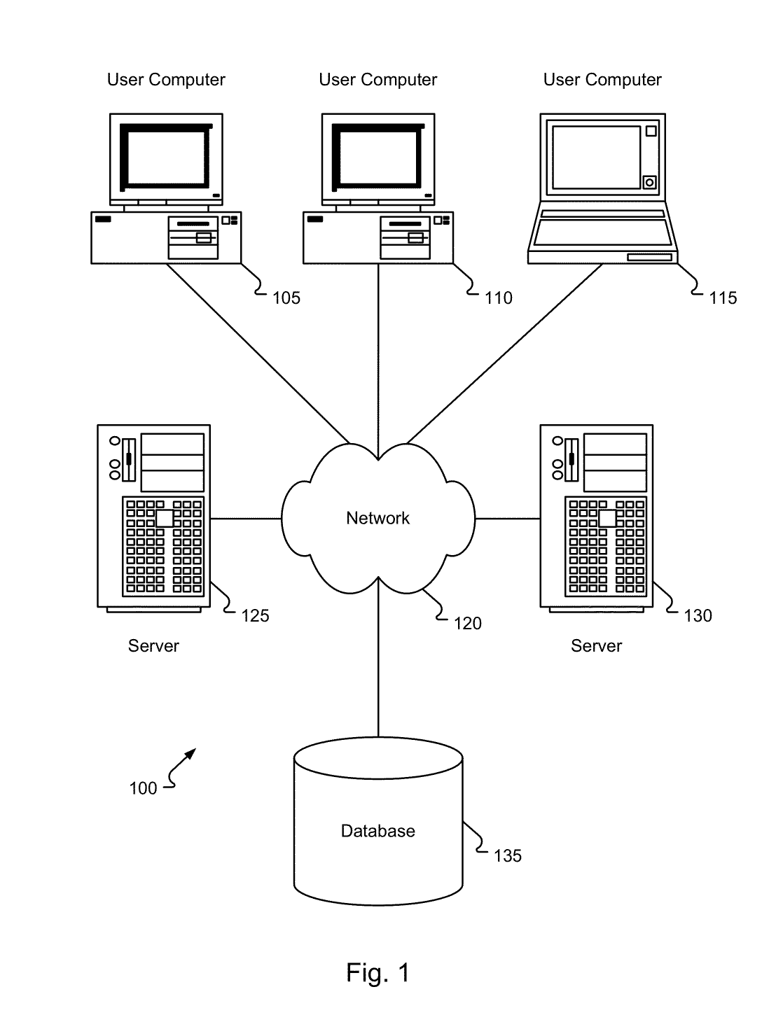

Referring to FIG. 1, an example network system is provided that may be used in connection with the system and method disclosed herein. More specifically, FIG. 1 illustrates a block diagram of a system 100 that may use a web service connector to integrate an application with a web service. The system 100 includes one or more user computers 105, 110, and 115. The user computers 105, 110, and 115 may be general purpose personal computers (including, merely by way of example, personal computers and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 105, 110, 115 may also have any of a variety of applications, including for example, database client and/or server applications, and web browser applications. Alternatively, the user computers 105, 110, and 115 may be any other electronic device, such as a thin-client computer, Internet-enabled mobile telephone, and/or personal digital assistant, capable of communicating via a network (e.g., the network 120 described below) and/or displaying and navigating web pages or other types of electronic documents. Although the exemplary system 100 is shown with three user computers, any number of user computers may be supported.

System 100 further includes a network 120. The network 120 may be any type of network familiar to those skilled in the art that can support data communications using any of a variety of commercially-available protocols, including without limitation TCP/IP, SNA, IPX, AppleTalk, and the like. Merely by way of example, the network 120 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system may also include one or more server computers 125, 130. One server may be a web server 125, which may be used to process requests for web pages or other electronic documents from user computers 105, 110, and 120. The web server can be running an operating system including any of those discussed above, as well as any commercially-available server operating systems. The web server 125 can also run a variety of server applications, including HTTP servers, FTP servers, CGI servers, database servers, Java servers, and the like. In some instances, the web server 125 may publish operations available as one or more web services.

The system 100 may also include one or more file and/or application servers 130, which can, in addition to an operating system, include one or more applications accessible by a client running on one or more of the user computers 105, 110, 115. The server(s) 130 may be one or more general purpose computers capable of executing programs or scripts in response to the user computers 105, 110 and 115. As one example, the server may execute one or more web applications. The web application may be implemented as one or more scripts or programs written in any programming language, such as Java™, C, C#™ or C++, and/or any scripting language, such as Perl, Python, or TCL, as well as combinations of any programming/scripting languages. The application server(s) 130 may also include database servers, including without limitation those commercially available from Oracle, Microsoft, Sybase™, IBM™ and the like, which can process requests from database clients running on a user computer 105.

In some embodiments, an application server 130 may create web pages dynamically for displaying the development system. The web pages created by the web application server 130 may be forwarded to a user computer 105 via a web server 125. Similarly, the web server 125 may be able to receive web page requests, web services invocations, and/or input data from a user computer 105 and can forward the web page requests and/or input data to the web application server 130.

In further embodiments, the server 130 may function as a file server. Although for ease of description, FIG. 1 illustrates a separate web server 125 and file/application server 130, those skilled in the art will recognize that the functions described with respect to servers 125, 130 may be performed by a single server and/or a plurality of specialized servers, depending on implementation-specific needs and parameters.

The system 100 may also include a database 135. The database 135 may reside in a variety of locations. By way of example, database 135 may reside on a storage medium local to (and/or resident in) one or more of the computers 105, 110, 115, 125, 130. Alternatively, it may be remote from any or all of the computers 105, 110, 115, 125, 130, and in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10i™, that is adapted to store, update, and retrieve data in response to SQL-formatted commands.

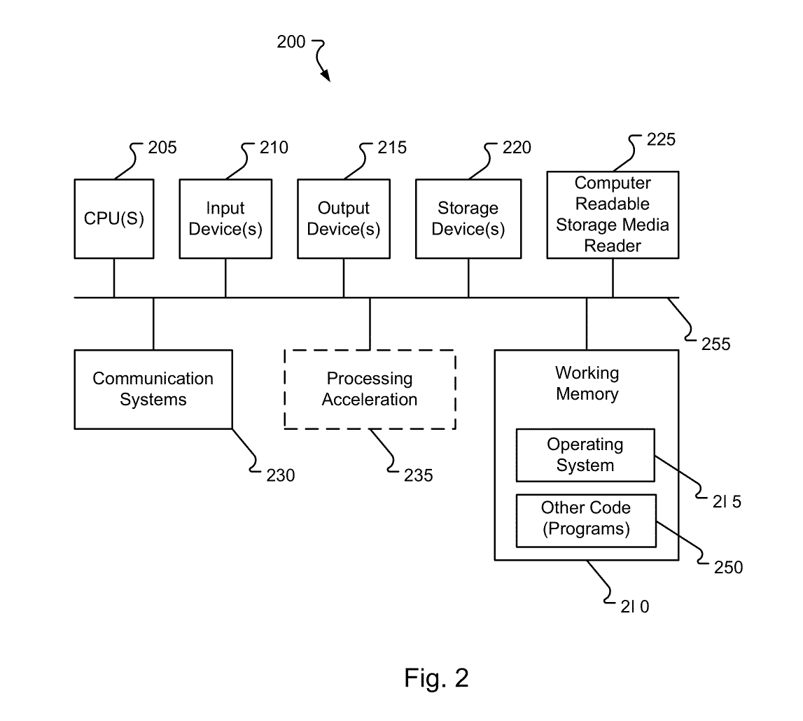

Referring to FIG. 2, an example computer system is provided that may be used in connection with the system and method disclosed herein. More specifically, FIG. 2 illustrates one embodiment of a computer system 200 upon which a web service connector or components of a web service connector may be deployed or executed. The computer system 200 is shown comprising hardware elements that may be electrically coupled via a bus 255. The hardware elements may include one or more central processing units (CPUs) 205; one or more input devices 210 (e.g., a mouse, a keyboard, etc.); and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225; a communications system 230 (e.g., a modem, a network card (wireless or wired), an infra-red communication device, etc.); and working memory 240, which may include RAM and ROM devices as described above. In some embodiments, the computer system 200 may also include a processing acceleration unit 235, which can include a DSP, a special-purpose processor and/or the like.

The computer-readable storage media reader 225 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as program code implementing a web service connector or components of a web service connector. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

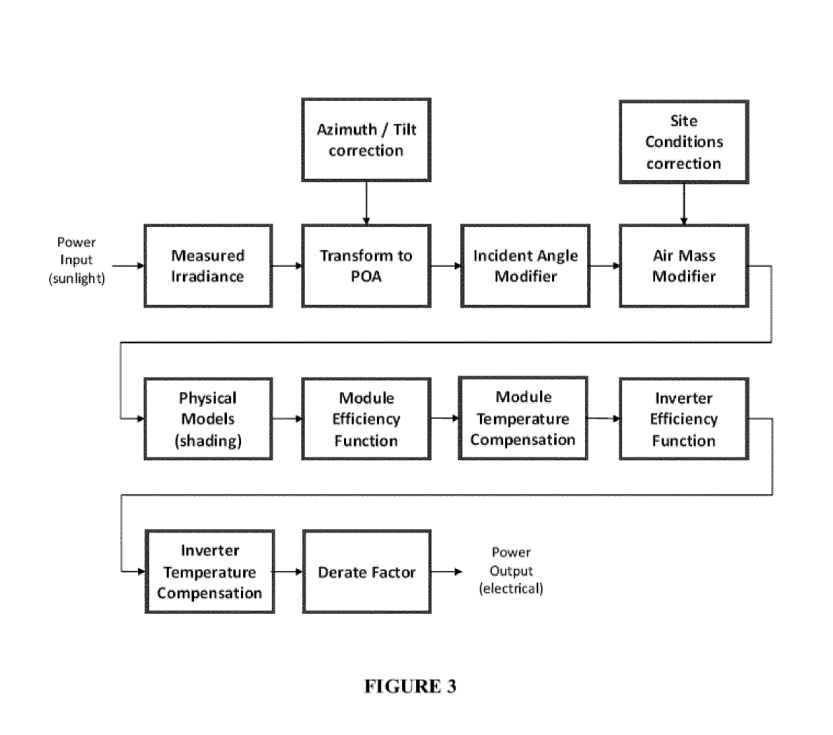

Referring to FIG. 3, a schematic diagram shows components taken into consideration for a prior art PV system model. Each of the elements or parameters relate to corrections or considerations that can be considered in generating an accurate and precise PV system model. First, a correction can be calculated for the position of the irradiance sensor (that is, the precise direction and angle at which the sensor is pointing) located at the PV array as compared to the actual plane of the array (POA). With this correction, a more accurate measure of the amount of photons that strike the surface of the array can be determined. Therefore according to FIG. 3, the first few steps shown there relate to an initial correction to determine photon intensity. First there is a measured irradiance, which is then transformed to the plane of the array (POA) which itself takes into consideration the necessary azimuth/tilt correction, and an incident angle modifier that accounts for thickness of the glass over the PV cells and a calculated percentage of the photons which actually pass through the glass to strike the PV cells, this modifier also taking into account the angle of the sun. Air mass modification relates to the mass through the photons must travel, which also affects the number of photons that will strike the PV array. For example, colder air has different characteristics and warmer air in terms of mass, as well as the angle of the sun as it passes through the atmosphere. Another element for consideration in the model is the shading effects around the PV array, such as the extent to which adjacent PV arrays may shade one another as the sun traverses the sky. This element may also include considerations for shading by trees, buildings, or other adjacent structures. The module efficiency function relates to how efficient the particular PV cells are in converting sunlight to electricity, and can for example represent an industry recognized efficiency rating. It is also known that the efficiency of the PV array is affected by temperature; therefore, a temperature compensation factor may be considered as well. Another component or element to consider is the efficiency of the inverter system used in the array, that is, the system that converts DC power to AC power for use in the grid. The inverter itself is also affected by temperature; accordingly and inverter temperature compensation factor may also be considered in developing the model. Finally shown in FIG. 3 is a derate factor that may be considered, and this factor relates to line losses, such as the amount of resistance provided in the wiring of the PV array. FIG. 3 is therefore intended to represent some common or known factors that may be considered in developing a PV system model.

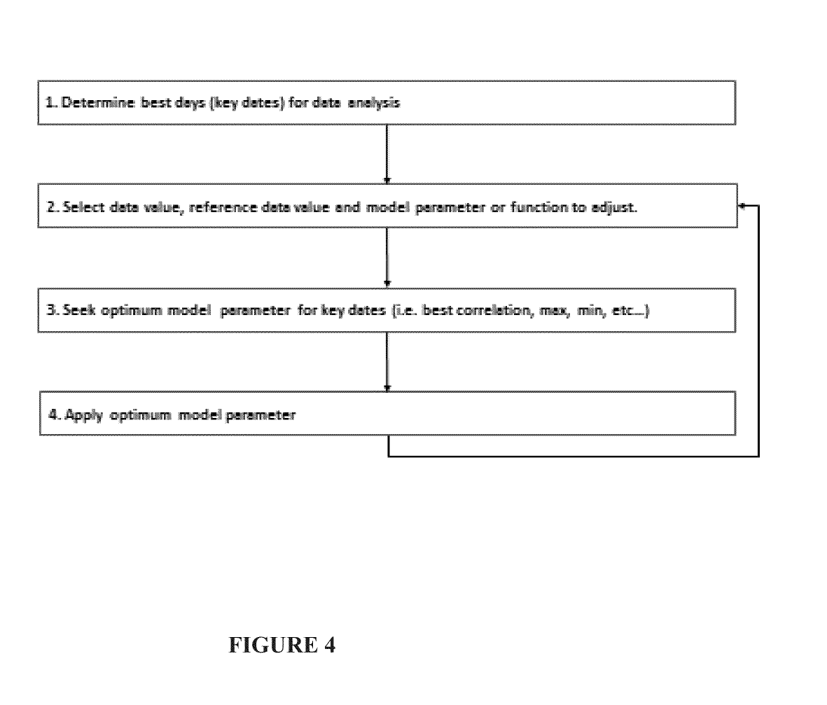

Referring to FIG. 4, steps of the method of the invention include: (1) selecting days of historical data that will result in the highest quality results (e.g. high energy output, minimal clouds); (2) determining key metrics and relationships between measured data and site characteristics to identify how to optimize model parameters; (3) running simulations of the model over the key days to determine the best value for each model parameter that results in the closest match between the model and measured system output; and (4) conducting iterations of the simulations to adjust various model parameters. By conducting this method with actual data within a PV system model, the user can better determine the actual performance of the PV system as opposed to how the system was designed with an expected performance; such expected performance not likely to match the actual performance of the system. Because there such a potentially large number of factors that must be considered in accurately and precisely modeling the PV system, conducting the method according to FIG. 4 in an iterative and repeating manner should greatly assist in measuring actual performance of the PV system. Based upon the performance criteria as measured with actual data, model parameters or components can be adjusted

An additional feature of the method include applying and adjusting non-linear functions to further fine-tune the original PV system model and reduce errors between the original PV system model and actual results as measured system outputs. The approach of applying and adjusting nonlinear functions to further fine-tune the original PV system model can be specifically applied to selected DC strings or groups of DC strings to assess PV module performance within small regions of a larger PV system.

Another feature of the method includes applying physical site characteristics such as inter-row shading and other obstructions to further fine-tune the model prediction. These site-specific characteristics are used to supplement the original PV system model by introducing additional factors outside of the original system parameters that ultimately affect system performance.

A revised performance index, Pindex, can be used to calculate the financial impact of performance losses. An evaluation can be conducted regarding the contribution for each component of the system model to determine the out the production and financial impact of performance losses. For example, an evaluation can be made for the contribution for each component of the PV system model to determine the production and financial impact of certain effects, such as shading from tree or other obstacle. The revised baseline model can be periodically adjusted as the PV system ages to adapt to changing component behavior.

As a specific example, the determination for the orientation (azimuth) of a PV array can be used. The array azimuth and tilt, along with the latitude/longitude and time of day are used to transform the measured irradiance into the plane of array (POA) irradiance value, which represents the total amount of sunlight falling on the surface of the PV cells (watts/meter²).

Regardless of the parameter being optimized, a first step of the method is to determine the best set of historical data to use. Since the performance index is the ratio of actual to calculated power, the values at low power levels are usually ignored since they are much more prone to variations in measured values and errors in the model. In addition, the contribution to overall production is lower at those times and therefore less relevant.

For these reasons, one option is to evaluate the days with the highest energy output relative to the expected “blue-sky” production for each day. These selected “key” dates are also further filtered by selecting those days with the smoothest measured irradiance to minimize transient effects from passing clouds. Using historical data from six months to one year is desired as this covers the widest range of solar azimuths, elevations and temperatures.

In order to optimize the parameter for the array azimuth, a result is defined that corresponds to how well a given azimuth value fits the data. Since the azimuth is used to calculate the POA irradiance from the measured value, the power output of the system should correlate most closely to the POA irradiance when the azimuth parameter is correct.

To find the optimal azimuth, the entire PV model calculation is run for each key date over a range of azimuth values surrounding the expected azimuth. For example, if a system is presumed to be pointed due south (180°), then the calculation would be run at multiple azimuths from 170° through 190°. The correlation between the measured power output and calculated POA irradiance is determined for each azimuth. By fitting a polynomial to the set of correlations as a function of azimuth, the peak correlation and therefor the optimal azimuth can be determined for each key day. The final result is then simply calculated as the average of those optimal daily azimuths.

This calculated azimuth may not exactly match the installed azimuth of the system for a number of reasons, such as shading, reflections or other effects, however, for the purpose of the model, this calculated azimuth effectively represents the best value to use when calculating the modeled power output.

Additional parameters are then optimized in a similar fashion, further reducing the overall error in the existing PV system model. Optimization of parameters is completed in an iterative process, refining, and possibly re-analyzing previously optimized parameters in order to converge on an optimal set of parameters.

More complex relationships than the calculation of POA from measured irradiance exist surrounding other components of PV systems, such as the absorption of sunlight as a function of incident angle, inverter efficiency as a function of power level and temperature, PV cell efficiency as a function of temperature and irradiance, etc. These non-linear relationships are often modeled using a curve fit.

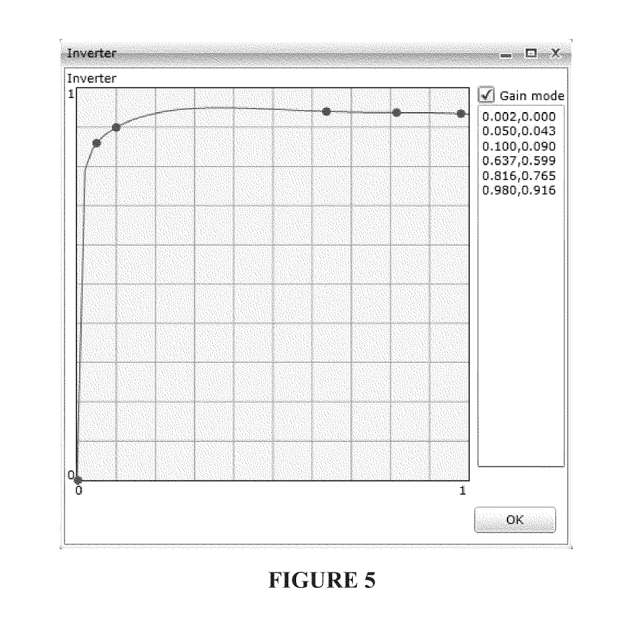

Referring to FIG. 5, a typical inverter efficiency curve is shown. The x-axis of the curve represents power in to the inverter and the y-axis represents power out divided by power in, so represents the efficiency of the inverter. Functions such as the inverter efficiency curve can be inserted into the PV system model at appropriate points in the process to further tune the model. Various mathematical techniques exist for fitting the curves to data. In this case, the inverter efficiency curve can be derived from measurements of input and output power. The resulting function will be more accurate than the general model or manufacturer's specification for the inverter efficiency.

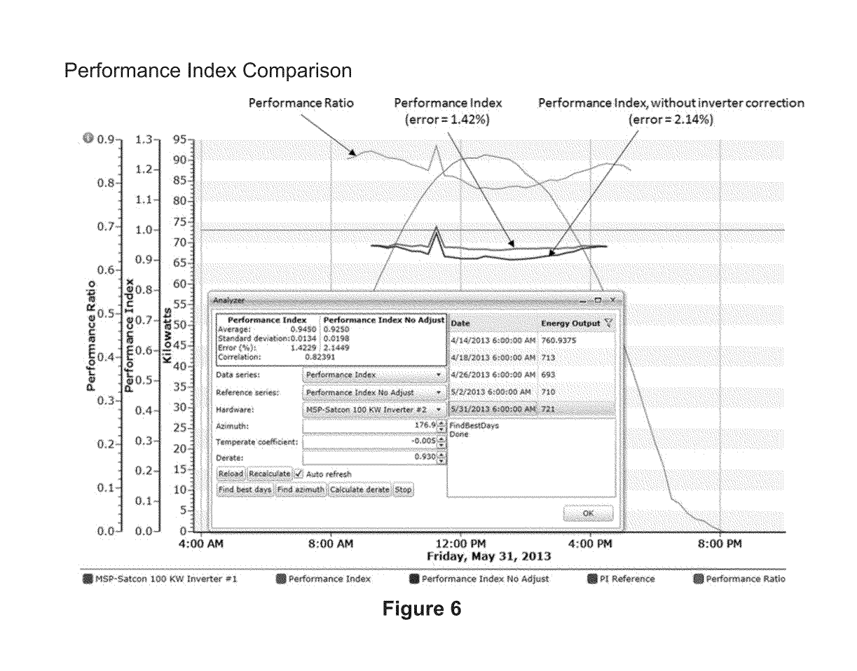

Referring to FIG. 6, a graph is provided to show a performance index with and without a derived inverter correction function applied. Ideally, a performance index would be a horizontal line, indicating that the model perfectly matches the actual performance. With the inverter correction applied, the error is reduced from 2.14% to 1.42% as shown. FIG. 6 also depicts a typical power output curve for a day of production from a PV system. The curve resembles a sine or parabolic function curve with the peak as solar noon, although the shape of the curve is affected by the various conditions that the model considers. The classic performance ratio curve shows a significant drop at solar noon as this does not consider many of the secondary effects. The simple performance index shows significantly less deviation throughout the day. Finally, the complete, fine-tuned, performance index shows very little error and is almost perfectly flat. One noticeable peak in performance at approximately 11:00 AM is due to a cable that briefly shades the irradiance sensor, resulting in a lower than actual irradiance and consequently a higher than expected performance index.

Certain relationships between operating conditions and performance may be best described with multi-dimensional functions. These functions can be developed by analyzing patterns in the data either manually using data visualization tools, or automatically with multivariate analysis. Shading impacts from obstacles are one good example since these effects typically vary as a function of both the azimuth and elevation of the sun.

Shading analysis is often performed during the design process to model losses. While these models could be used to improve the performance model, it's often sufficient to identify and model these losses from the data, especially as conditions on the site may change over time (i.e. due to vegetation growth). Systems with DC string or sub array monitoring hardware can expose these types of losses with simple graphs that show correlations between the sun position and power output. This information is then applied to the PV model to adjust the performance expectation at the appropriate times.

PV systems are often constructed with monitoring of the DC components, either down to the individual string level or in groups of strings (sub array). This analysis technique can be used at DC level to provide performance index values for each separately monitored DC section. Comparisons between the DC performance indexes can be used to identify component failures and soiling within small regions of the array.

The following list identifies some of the PV model parameters and dependencies that may be optimized or modeled with non-linear functions to improve overall accuracy in accordance with the present invention:
1. Module azimuth/tilt;
2. Module temperature coefficient as a function of module temperature;
3. Module efficiency as a function of incident angle, irradiance level (direct beam, diffuse and albedo components), temperature, humidity;
4. Module efficiency as a function of spectral characteristics of sunlight, position of the sun;
5. Line losses, inverter efficiency as a function of ambient temperature, power level, voltage; and
6. Shading effects between rows of PV modules or obstructions as a function of sun azimuth, elevation and irradiance.
7. Measurement errors due to sensor inaccuracy, obstructions or other effects.

Existing operational models of PV systems can be vastly improved with the method of the present invention that takes advantage of tuned parameters and empirically derived functions. These changes to an existing PV system model provide an accurate characterization of system performance and a reference that can subsequently be used to identify of component failures and other sources of performance degradation. The comparison of the actual to existing model performance allows the determination of production and financial impact due to any losses to be quantified and corrected appropriately. Further, the contribution of each component in the model can be isolated to quantify the loss due to individual elements, such as shading from a particular obstruction.

What is claimed is:

1. A system for modeling photovoltaic power (PV) systems comprising:
a plurality of photovoltaic strings for converting sunlight into electrical energy;
a combiner for combining output signals of said plurality of photovoltaic strings;
an inverter for converting the DC output signals of a plurality of combiners into AC power; and
a sensor for detecting data associated with said plurality of photovoltaic strings; a monitoring system for monitoring the performance of a photovoltaic array, comprising:
a memory;
a processor in connection with the memory, the processor operable to execute software modules, the software modules comprising a sensor or set of sensors for measuring at least one of ambient conditions including irradiance, temperature, wind speed, wind direction, humidity, rain, and snow;
a PV system model module operable to provide data and user interfaces associated with the determination of a performance index value defined as a ratio of measured power output to power output calculated from a PV system model;
a supplemental module operable to provide data and user interfaces associated with model simulations of the PV system to identify and value projected or modeled PV system performance versus actual PV system performance, the supplemental module being further operable to select significant days of historical data, identify relevant metrics and relationships between measured data and site characteristics to identify how to optimize model parameters, run simulations of the PV system model over the selected days to determine a value for each model parameter that results in a match between a selected model parameter and corresponding measured system output, and conduct iterations of the simulations to adjust selected model parameters; and
a web application operable to receive user-selectable conditions and to display performance data associated with the data entry.

2. A system, as claimed in claim 1, wherein said model parameters includes a selected model parameter including a module azimuth or tilt, said selected model parameter being modeled with non-linear functions to improve overall accuracy in modeling of the PV system model.

3. A system, as claimed in claim 1, wherein said model parameters includes a selected model parameter including a module temperature coefficient as a function of module temperature, said selected model parameter being modeled with non-linear functions to improve overall accuracy in modeling of the PV system model.

4. A system, as claimed in claim 1, wherein said model parameters includes a selected model parameter including a module efficiency as a function of at least one of an incident angle, an irradiance level, temperature, and humidity, said selected model parameter being modeled with non-linear functions to improve overall accuracy in modeling of the PV system model.

5. A system, as claimed in claim 1, wherein said model parameters includes a selected model parameter including a module efficiency as a function of at least one of spectral characteristics of sunlight and position of the sun, said selected model parameter being modeled with non-linear functions to improve overall accuracy in modeling of the PV system model.

6. A system, as claimed in claim 1, wherein said model parameters includes a selected model parameter including a module efficiency as a function of at least one of line losses, inverter efficiency as a function of ambient temperature, power level, and voltage, said selected model parameter being modeled with non-linear functions to improve overall accuracy in modeling of the PV system model.

7. A system, as claimed in claim 1, wherein said model parameters includes a selected model parameter including a module efficiency as a function of shading effects between rows of PV modules or obstructions as a function of sun azimuth, elevation and irradiance, said selected model parameter being modeled with non-linear functions to improve overall accuracy in modeling of the PV system model.

8. A method for modeling photovoltaic power (PV) systems, the method comprising:
providing a photovoltaic system comprising:
(i) a photovoltaic string for converting sunlight into electrical energy;
(ii) a combiner for combining the output signals of a plurality of photovoltaic strings;
(iii) an inverter for converting the DC output signals of a plurality of combiners into AC power; and
(iv) a sensor for detecting data associated with a plurality of photovoltaic strings;
(v) a sensor or set of sensors for measuring at least one of many ambient conditions, such as irradiance, temperature, wind speed, wind direction, humidity, rain, snow, etc.
providing a PV system model module associated with a computer processor operable to provide data and user interfaces associated with the determination of a performance index value defined as a ratio of measured power output to power output calculated from a PV system model;
providing a supplemental module operable associated with said computer to provide data and user interfaces associated with model simulations of the PV system to identify and value projected or modeled PV system performance versus actual PV system performance, the supplemental module being further operable to select significant days of historical data, identify relevant metrics and relationships between measured data and site characteristics to identify how to optimize model parameters, run simulations of the PV system model over the selected days to determine a value for each model parameter that results in a match between a selected model parameter and corresponding measured system output, and conduct iterations of the simulations to adjust selected model parameters;
determining, via a processor, a comparison between selected model parameters and corresponding measured system outputs to determine discrepancies, and to adjust said selected model parameters to more closely match the corresponding system outputs; and
displaying said comparison on at least one of a user interface display associated with a computer, a text message, an email message, or a printed report.

9. A method, as claimed in claim 8, wherein said model parameters includes a selected model parameter including a module azimuth or tilt, said selected model parameter being modeled with non-linear functions to improve overall accuracy in modeling of the PV system model.

10. A method, as claimed in claim 8, wherein said model parameters includes a selected model parameter including a module temperature coefficient as a function of module temperature, said selected model parameter being modeled with non-linear functions to improve overall accuracy in modeling of the PV system model.

11. A method, as claimed in claim 8, wherein said model parameters includes a selected model parameter including a module efficiency as a function of at least one of an incident angle, an irradiance level, temperature, and humidity, said selected model parameter being modeled with non-linear functions to improve overall accuracy in modeling of the PV system model.

12. A method, as claimed in claim 8, wherein said model parameters includes a selected model parameter including a module efficiency as a function of at least one of spectral characteristics of sunlight and position of the sun, said selected model parameter being modeled with non-linear functions to improve overall accuracy in modeling of the PV system model.

13. A method, as claimed in claim 8, wherein said model parameters includes a selected model parameter including a module efficiency as a function of at least one of line losses, inverter efficiency as a function of ambient temperature, power level, and voltage, said selected model parameter being modeled with non-linear functions to improve overall accuracy in modeling of the PV system model.

14. A method, as claimed in claim 8, wherein said model parameters includes a selected model parameter including a module efficiency as a function of shading effects between rows of PV modules or obstructions as a function of sun azimuth, elevation and irradiance, said selected model parameter being modeled with non-linear functions to improve overall accuracy in modeling of the PV system model.
